(19) United States
(12) Patent Application Publication
(10) Pub. No.: US 2024/0396212 A1
(43) Pub. Date: Nov. 28, 2024

(54) MILLIMETER WAVE BASE STATION ANTENNA

(71) Applicant: Samat Iskakov, Rockville, MD (US)

(72) Inventor: Samat Iskakov, Rockville, MD (US)

(21) Appl. No.: 18/421,573

(22) Filed: Jan. 24, 2024

Related U.S. Application Data
(60) Provisional application No. 63/440,842, filed on Jan. 24, 2023.

(51) Int. Cl. H01Q 3/36; H01Q 1/24; H01Q 3/26; H01Q 15/00

(52) U.S. Cl. CPC H01Q 3/36; H01Q 3/2611; H01Q 15/0086; H01Q 1/246

(57) ABSTRACT

A base station antenna that operates in a 5G mmWave frequency band at cellular communications base stations to provide two-way communication channels with user equipment such as smart phones, laptops, or tablets. The base station antenna includes a continuous and spherical reflector and a rectangular circularly curved waveguide. The continuous and spherical reflecting surface of the antenna combined with a rectangular circularly curved waveguide provides a narrow electronically steerable beam reaching a wide range of directions up to ±85° without scan loss and ±90° with partial scan loss. The antenna is a structure that merges the conventional solid quasi paraboloid aperture with a slotted waveguide feed constructed of advanced metamaterial tunable slots and radio equipment. Steering in the required direction is achieved by electronically activating a certain number of slots along the feed waveguide.

### CROSS-REFERENCE TO RELATED APPLICATIONS

This application claims priority from of a U.S. Provisional Patent Application Ser. No. 63/440,842, filed on Jan. 24, 2023, the disclosures of which is incorporated herein by reference in their entirety.

### FIELD OF INVENTION

The present invention relates to a base station antenna, and more particularly, the present invention relates to a base station antenna with a spheroid reflector and a curved waveguide with rectangular slots as radiating elements.

### BACKGROUND

The modern systems of broadband wireless communication in 5G mmWave bands use active phased array antennas for fast controlling of the BS antenna's narrow directional beam toward UE, therefore tracking user equipment (UE) to provide maximum transmit energy on down-link, maximum receive gain on up-link, while dramatically minimizing intercellular co-channel interference. Usually, a base station (BS) operating in mmWave band has an active phased array antenna constructed of 8×8 or 16×16 patch antenna elements with gain range from 26 to 32 Decibels relative to isotropic (dBi). Users' statistics of 5G cellular networks in standalone mode in the millimeter wave range show a confident coverage in the line of sight (LOS) not exceeding 30-50 meters while trees, foliage, windows, walls, and the like immediately interrupt the connection regardless of the distance. Comparing existing LOS coverages in LTE UHF and S band ranging from 1 to 3 Km to the achieved coverages in mmWave bands, the differences in the covered areas are as much as 100 times. There are many possible reasons for this, the primary is that the mmWave frequency in an average is 10-20 times higher than the frequencies in UHF and S-band. The free space loss is proportional to the frequency in square reaching a free space loss (FSPL) difference as much as 33 dB.

However, if the estimated directional FSPL is compared according to the Friis law, the difference in the directional FSPL does not exceed 1 dB as shown in Table 1 for various cellular communication bands.

TABLE 1

| | B13 UHF- | | n261 mmWave- |
|---|---|---|---|
| Table 1 | Band | B2 S-Band | Band |
| Average frequency, MHz | 750 | 1950 | 28000 |
| LOS distance, meter | 1000 | 1000 | 1000 |
| FSPL omni, dB | 89.9 | 98.2 | 121.4 |
| BS antenna gain, dBi | 12 | 15 | 26 |
| UE antenna gain, dBi | −5 | 0 | 11.5 |
| FSPL directional, dB | 82.9 | 83.2 | 83.9 |

The high difference of 31.5 dB in omni-FSPL between mmWave band and UHF band is due to the law of electromagnetic wave propagation. However, directional FSPL is about the same for all frequency bands in order to compensate for higher frequency losses, therefore one could use antennas with greater gain in mmWave band than the gain of antennas in lower band. The quick link budget for 1000-meter distance shows that signal-to-noise ratio (SNR) values estimated for typical BS and UE effective isotropic radiation power (EIRP) could reach more than 33 dB for all three bands while using FSPL numbers above in Table 1. That SNR value is good enough to operate with a modulation order up to 8 (256-QAM) and therefore provide the highest throughput. Actual performance for 1000-meter distance firmly confirms this statement for UHF and S-band, but strongly denies it in mmWave band on uplink.

An average breaking point distance of about 200 meters LOS is noticed by the observers in non-standalone (NSA) mode where downlink operates in mmWave band while uplink operates in 4G LTE bands. It's evident that in standalone mode (SA), coverage is significantly lower than in NSA mode, confirming that the BS antenna is at fault for unsuccessful communication.

It turns out that the loss from the transmitter output to the receiver input is the same, but the coverage is completely different, which leads to a conclusion that the BS antenna has an inadequately low figure-of-merit (G/T) value, and as a result, has a very low sensitivity of the receiving part of the active phased array antenna.

The other drawback of the flat phased array antenna is its narrow scanning range for comparable gain and beamwidth.

Considering the essential use of mmWave bands in current network deployments, an industrial need is there for improvements in base station antennas having high throughput and reliability.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The main object of the invention is therefore directed to a method of constructing a fixed, motionless base station antenna with wide area rapid steerable communication beam that would achieve long distance SNR coverage in mmWave band to and from user equipment, keeping antenna beam coverage with acceptable pattern ripple between adjacent beams and overcome the problems described above.

It is another object of the invention that antenna is economical to manufacture.

It is still another object of the present invention that the antenna has a wide range of beam steering.

It is yet another object of the present invention that the antenna can be used for cellular tower and building roof installations.

It is a further object of the present invention that the antenna provides much larger coverage on both uplink and downlink.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 shows the principal geometry of the antenna from the Z axis point of view, according to an exemplary embodiment of the present invention.

FIG. 2 shows a close-up view of the principal geometry of the antenna from Z axis point.

FIG. 3 shows an elevation antenna pattern in relation to the base station height and user equipment height, according to an exemplary embodiment of the present invention.

FIG. 4 is a graph showing vertical antenna pattern and path loss value as function of angle elevation.

FIG. 5 is a graph showing relative gain as a function of steering angle, further showing the minimal steering angle step.

FIG. 6 is a perspective view of the base station antenna showing the spheroid reflector and curved waveguide feed, according to an exemplary embodiment of the present invention.

FIG. 7 is a 2D view of the base station antenna from Z axis point of view.

FIG. 8 is a 2D view of the base station antenna from Y axis point of view.

FIG. 9 shows a central fragment of the waveguide feed with the slots, wherein slots at the center of the waveguide feed can be selectively activated, according to an exemplary embodiment of the present invention.

FIG. 10 shows a right fragment of the waveguide feed with the slots, wherein slots at the right side of the waveguide feed can be selectively activated, according to an exemplary embodiment of the present invention.

FIG. 11 shows a left side fragment of the waveguide feed with the slots, wherein slots at the left side of the waveguide feed can be selectively activated, according to an exemplary embodiment of the present invention.

FIG. 12 is a planar view of the waveguide feed showing rectangular slots disposed throughout a length of the waveguide feed, according to an exemplary embodiment of the present invention.

FIG. 13 illustrates simulated 2D antenna beam steering range in horizontal plane and antenna gain.

FIG. 14 is a schematic view from Z axis of the antenna showing the beam steering range in horizontal plane.

FIG. 15 shows beam steering range in the horizontal plane.

FIG. 16 is schematic 2D view showing simulated antenna beam pattern in vertical plane and antenna gain.

FIG. 17 is a schematic 2D view showing the simulated feed pattern in horizontal plane and feed radiator gain.

FIG. 18 shows simulated feed pattern in vertical plane and feed radiator gain.

FIG. 19 shows simulated 2D feed pattern steering range in horizontal plane and feed gain

FIG. 20 shows down-link SNR coverage for 30° steering.

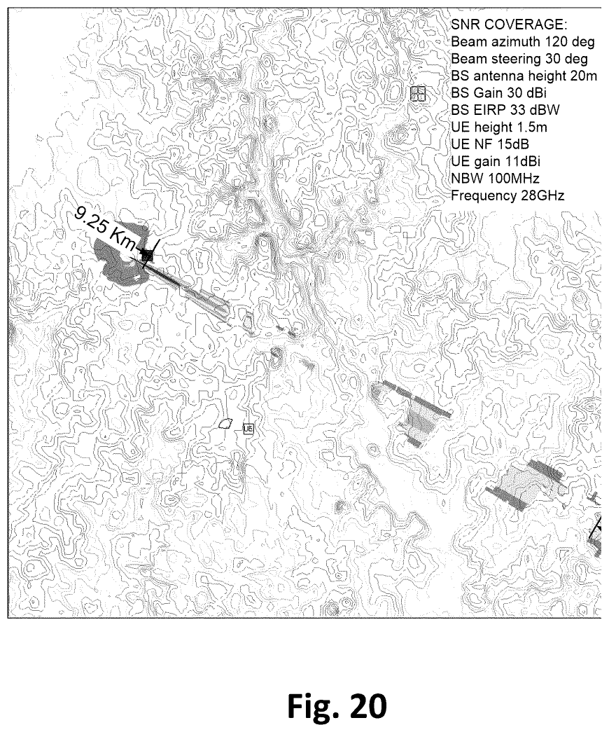

FIG. 21 shows up-link SNR coverage with the invented antenna at the base station.

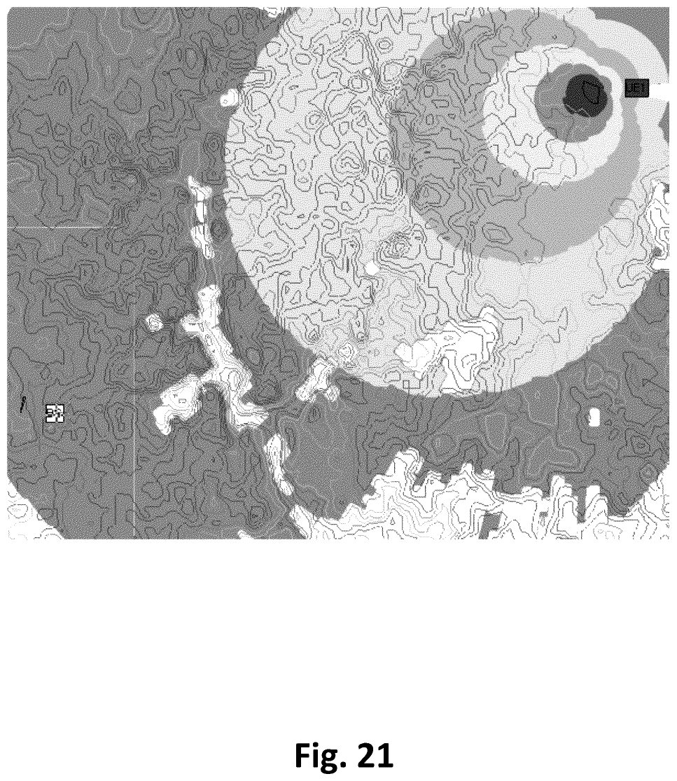

FIG. 22 shows the up-link SNR coverage with existing antenna at the base station.

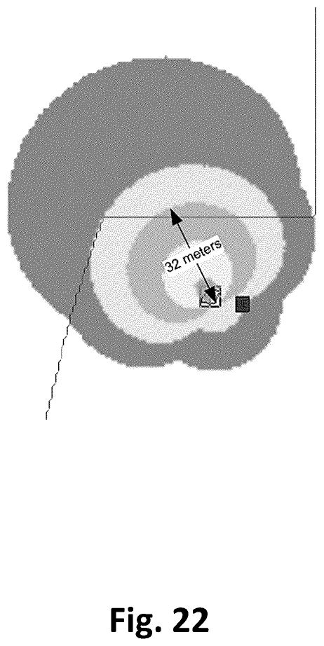

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a motionless base station antenna with wide area rapid steerable communication beam in mmWave band to and from user equipment. The disclosed base station antenna includes a continuous and spherical reflector and a rectangular circularly curved waveguide, which in combination allows achievement of exceptional antenna pattern directivity to cover large distances toward user equipment. The disclosed base station antenna operable in a 5G mmWave frequency band can be used in cellular communications to provide two-way communication channels with user equipments, such as smart phones, laptops, or tablets. The continuous and spherical reflecting surface of the antenna combined with a rectangular circularly curved waveguide provides a narrow electronically steerable beam reaching a wide range of directions up to ±85° without scan loss and ±90° with partial scan loss. The disclosed antenna incorporates a slotted rectangular circular curved waveguide feed constructed of advanced metamaterial tunable slots and radio equipment. Steering in the required direction can be achieved by electronically activating a certain number of slots along the feed waveguide. It is of a particular advantage to have a large enough conventional reflector aperture in combination with electronically steering pattern of the feed, for example on advanced metamaterial slots, that allows achievement of exceptional antenna pattern directivity to cover large distances toward UE. Any element antenna like mmWave patches or any other kind can be used to form an optimal radiation of the reflector.

In accordance with another aspect of the present invention, an antenna is constructed as a combination of sphere offset solid reflector with a rectangular circularly curved waveguide feed. One more aspect of the invention is the required feed radiation pattern that minimizes the main distortion from the quasi-paraboloid geometry of the reflector to have reliable coverage in vertical plane, which the invention defines minimal half beam width in vertical plane. The patent substantiates that optimized half beam width of the antenna in vertical plane would keep directional path loss constant in a wide range of vertical angles independent from distance so there is no need to steer the beam vertically toward UE. The antenna simulation software showed the invented antenna's ability to steer the beam horizontally in the range of ±85° without scan directivity loss. The invention details the geometry of the offset spherical reflector, X, Y, Z antenna dimension to have required antenna gain. To minimize the number of elementary radiators, the invention defines minimal angle between the two adjacent beam steering directions. The patent embodiments are confirmed by the simulation software WIPL-D for the antenna directivity pattern and EDX Signal for the SNR coverage.

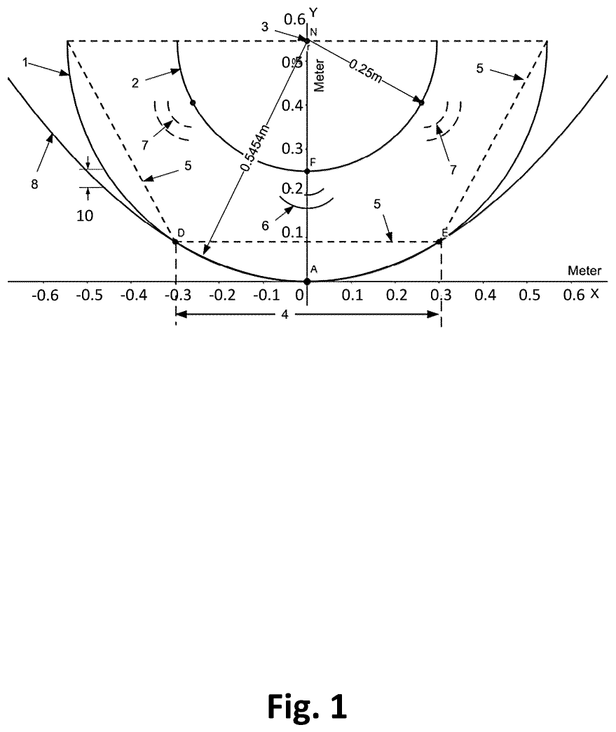

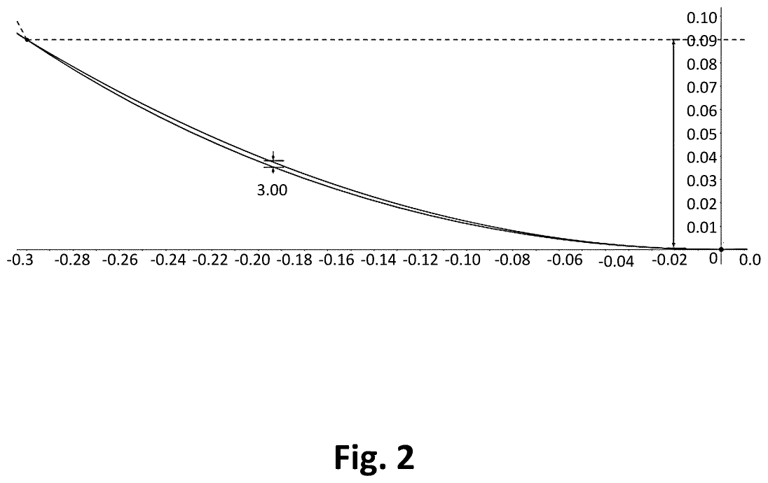

To implement a beam steering millimeter wave TX/RX antenna with a single receive channel and transmit channel operating in TDD or FDD mode, a solid metal reflector is used, which is an offset from a geometrically regular sphere, wherein the aperture of a rectangular profile forms the antenna pattern. The choice of a spherical surface is conditioned since an extended spherical reflecting surface has a uniform quasi-parabolic shape of essential reflection area for a variety of possible positions of the reflector feed located on circle 2 passing through the focal point of parabola 8. FIG. 1 shows a two-dimensional curve of circle 1 and parabola curve 8. Note that the curves are almost identical for chords 5, which limits the essential area of a spherical reflector. FIG. 2 shows the delta difference between the curves in a close-up view, which is a maximum of 3 mm. A spherical surface is intentionally used, sacrificing a slight loss in antenna gain due to a non-ideal parabolic surface, while still achieving a uniform reflective surface for almost 90% of the possible feed positions on focal curve 2. In general, an antenna with a quasi-parabolic reflector is constructed, where a waveguide feed in the form of a narrow semicircle 2 passing through the focal point is used as the feed line.

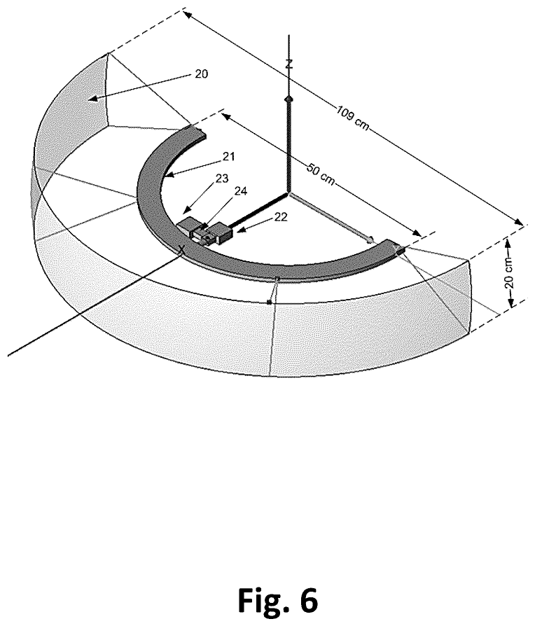

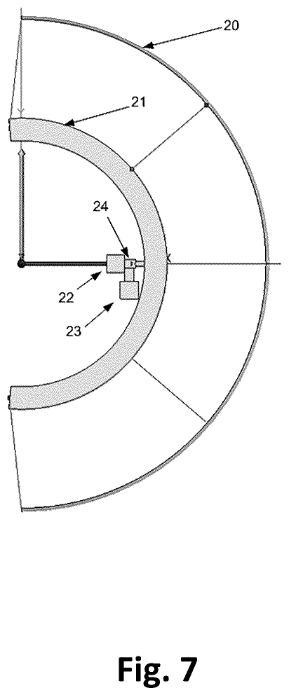

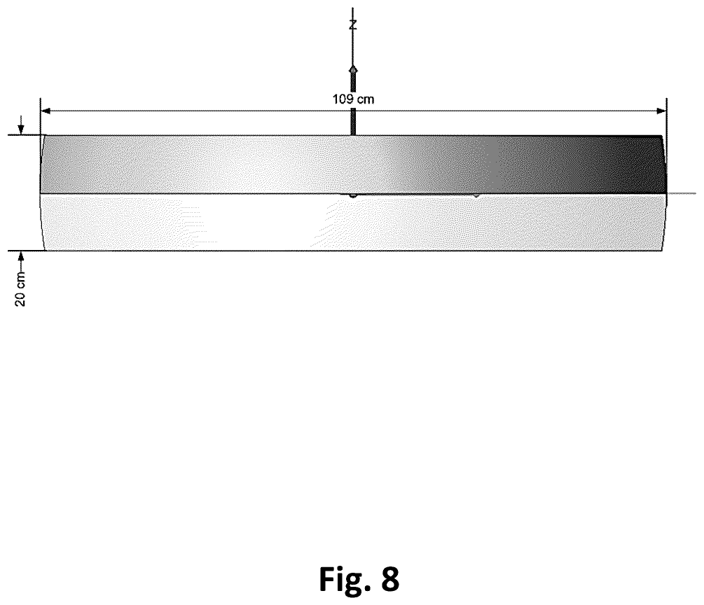

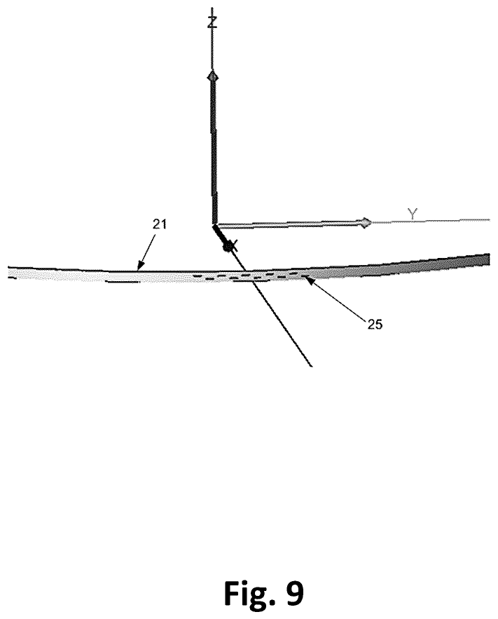

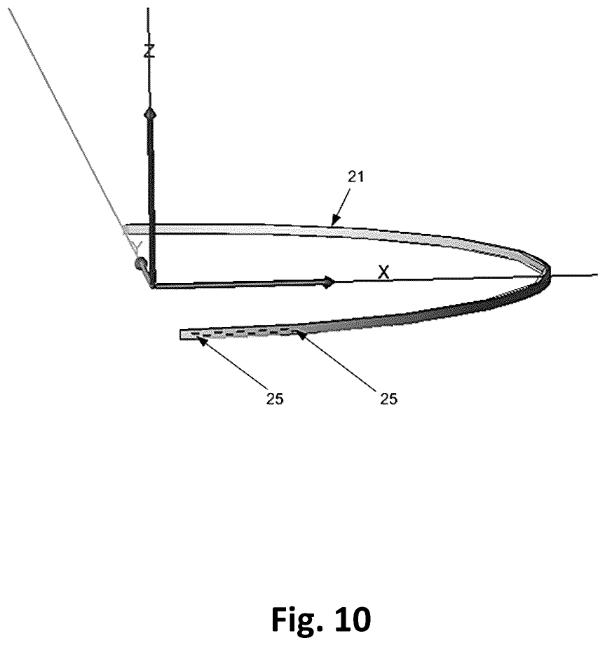

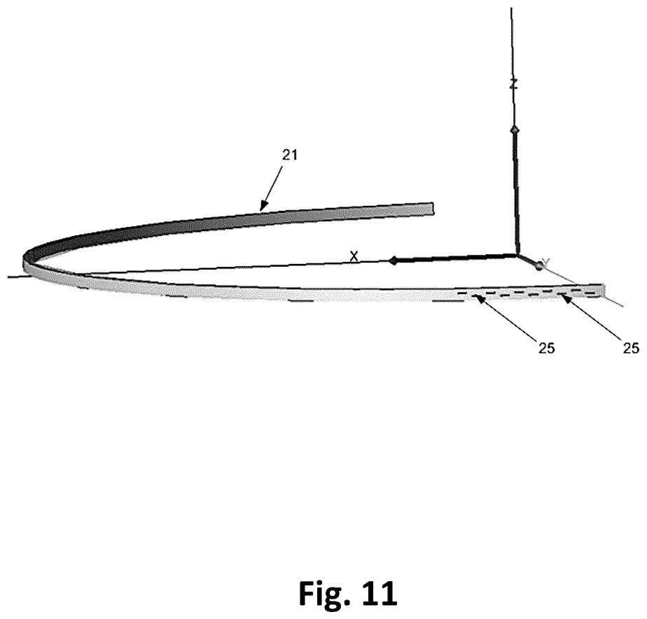

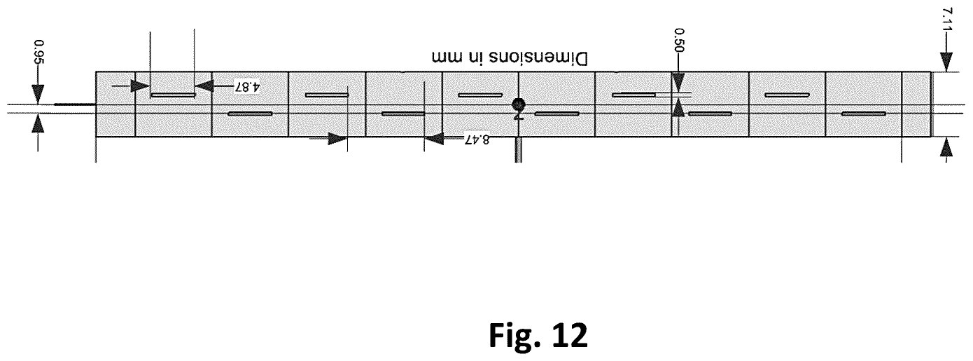

FIG. 6 shows a 3D view of the disclosed antenna. The antenna consists of spheroid reflector 20, spherically curved feed line 21 with controller inside, TX/RX switch 24, receiving low noise block 22, and block-up converter 24. FIG. 7 shows a 2D drawing of the antenna from Z axis point of view and FIG. 8 shows a 2D drawing of the antenna from Y axis point of view. In this case, aperture shadowing caused by the feeder line is insignificant and brings a negligible impact in antenna gain and radiation pattern distortion, but steering will be possible only in azimuthal plane. In case, a need is there to steer the radiation beam in two dimensions, then a feeder waveguide spherical surface can be used instead of a narrow strip of waveguide, which will lead to a significant shadowing of about 70% of the reflector, which is of course unacceptable. It should be noted that when the reflector surface is irradiated with a feed line in each direction, only a certain part of the reflector area, called the significant reflection zone, participates in the formation of the resulting radiation pattern. The width of the radiation pattern of the waveguide feed is chosen in such a way to minimize the power in those parts of the reflector where the divergence of the sphere from the parabola increases significantly and thereby negatively affects the resulting antenna gain. That is, in fact, for a certain direction of the radiation pattern, the equivalent antenna is a spheroid rectangle with dimensions comparable to the height of the reflector, and this is observed in a wide scanning range, up to the left and right edges of the antenna. The movement of the essential reflection zone and therefore the scanning of the beam is achieved by shifting the activated waveguide holes of the feed line. FIG. 9 shows 3D fragment of the antenna waveguide feed with the slots 25 activated at center, FIG. 10 shows 3D fragment of the antenna waveguide feed with the slots 25 activated at right, FIG. 11 shows 3D fragment of the antenna waveguide feed with the slots 25 activated at left and FIG. 12 shows a close-up 2D fragment of the antenna waveguide feed with the slots.

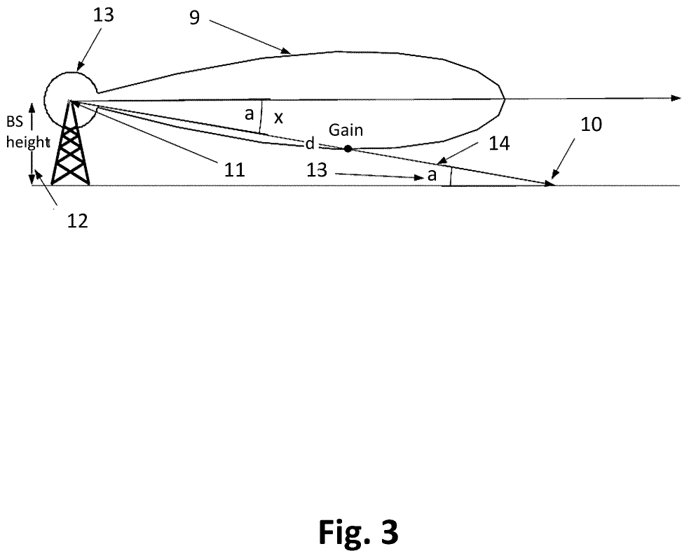

FIG. 3 illustrates calculation of the width of the antenna pattern in the vertical plane to avoid scanning in this plane, based on the idea that to provide equivalent losses of free space according to the Free's law, regardless of the angle in the direction of UE angle α 13 and, accordingly, the distance d to UE. The following postulate is affirmed: there must be a certain angle of the antenna beamwidth, at which the increase in the attenuation of free space depending on the angle/distance in the direction of the UE 14 is compensated by an increase in the directivity of the antenna with a horizontal beam and at the same time the attenuation of free space, taking into account the gains of the transmitting and the receive antenna remains acceptable in the direction of UE 14 to achieve good signal-noise-ratio (SNR).

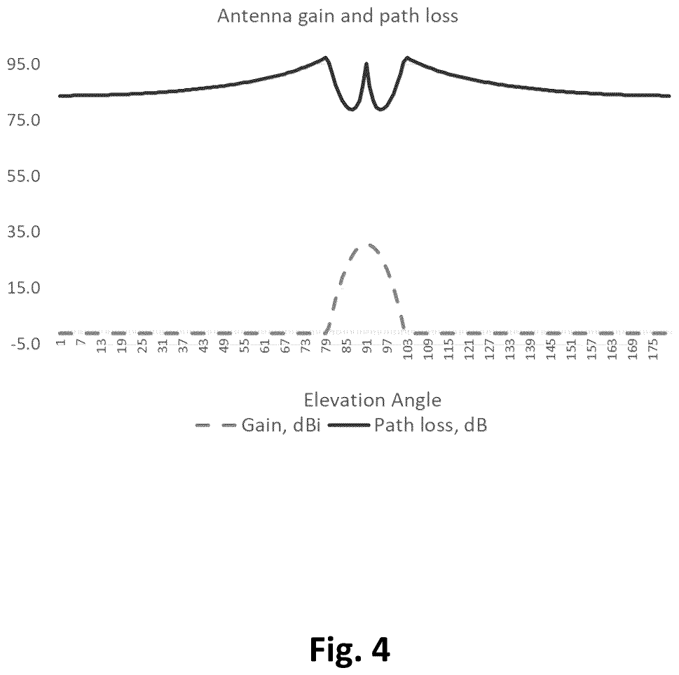

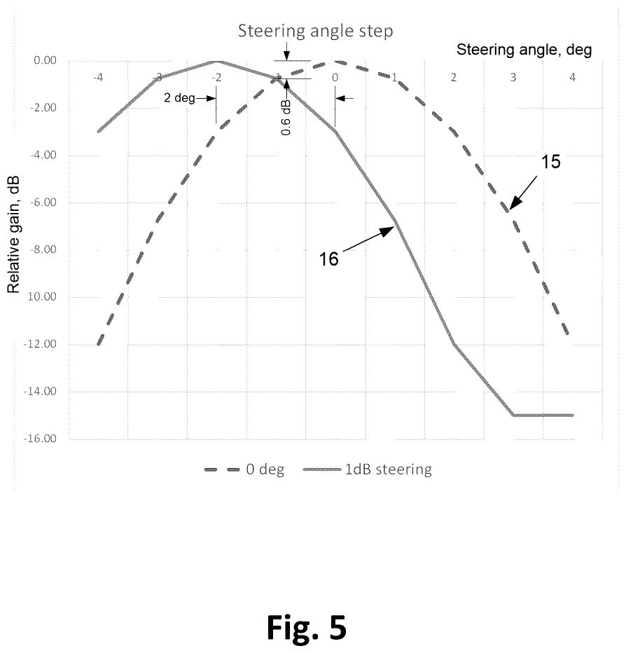

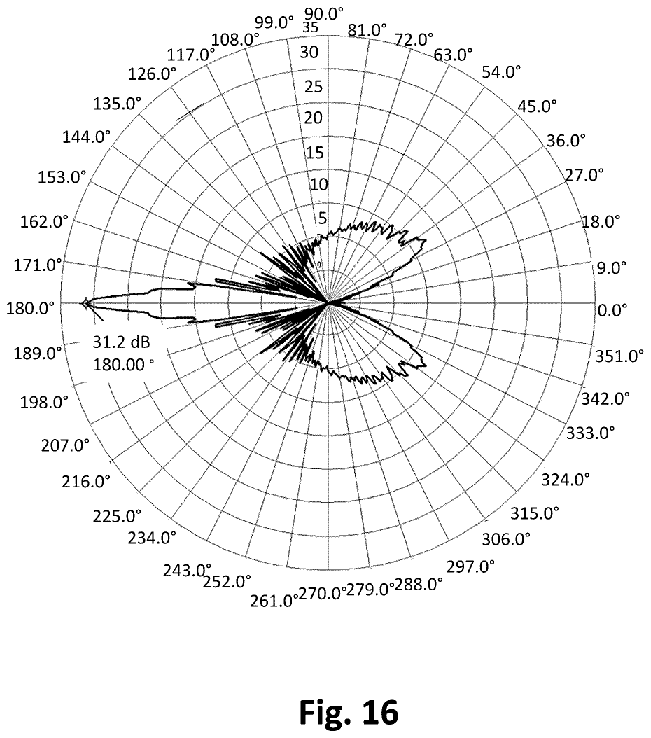

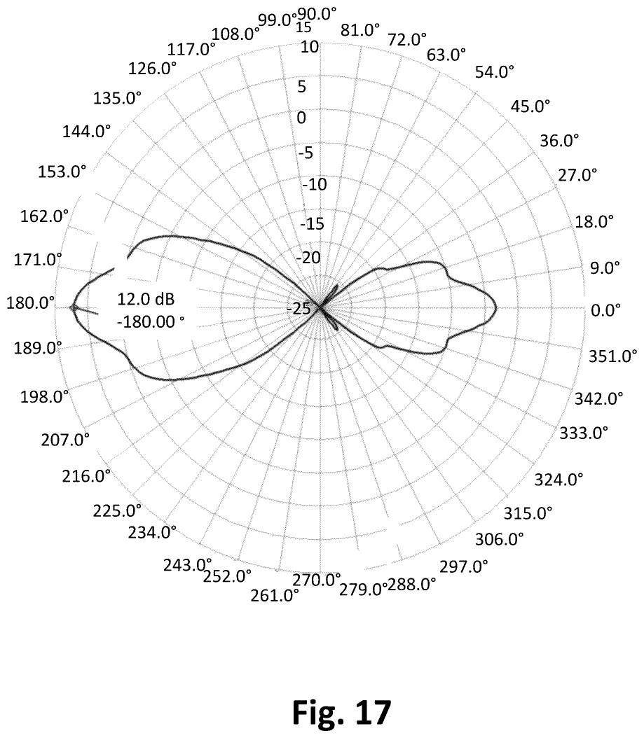

FIG. 4 illustrates the change in the gain of antenna 9 at the maximum distance of the UE from the cell tower 11 to the level of the side lobes 13 at the minimum distance. In this approach, this scanning beam antenna replicates a conventional fixed-beam cell-site antenna without scanning. The average gain of a conventional antenna, for example, in the S band is 17 to 22 dBi with a half power beamwidth of 4 to 8 degrees in the vertical plane and 40 to 65 degrees in the azimuthal plane. As stated in the section of previous achievements (results) for the millimeter wave range, the required gain of the designed antenna within 30-32 dBi was determined, which will provide sufficient figure-to-merit (sensitivity) of the antenna for operation at long distances on the uplink. Let's take the width of the radiation pattern corresponding to the traditional antenna and equal it to 6°. Then, according to the formula for calculating the antenna gain depending on the width of the radiation pattern, we can determine the required width of the radiation pattern in the azimuthal plane. Maximum steering loss between the adjacent discrete directions is assumed as 1 dB that provides minimal step angle 2° as shown on FIG. 5. FIG. 16 and FIG. 17 show azimuthal and elevation antenna pattern at 0° scan angle.

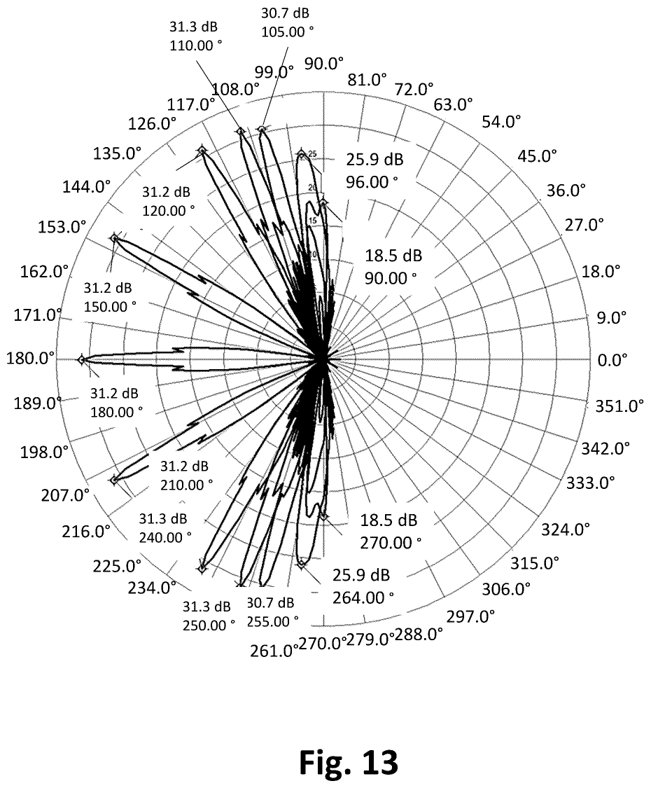

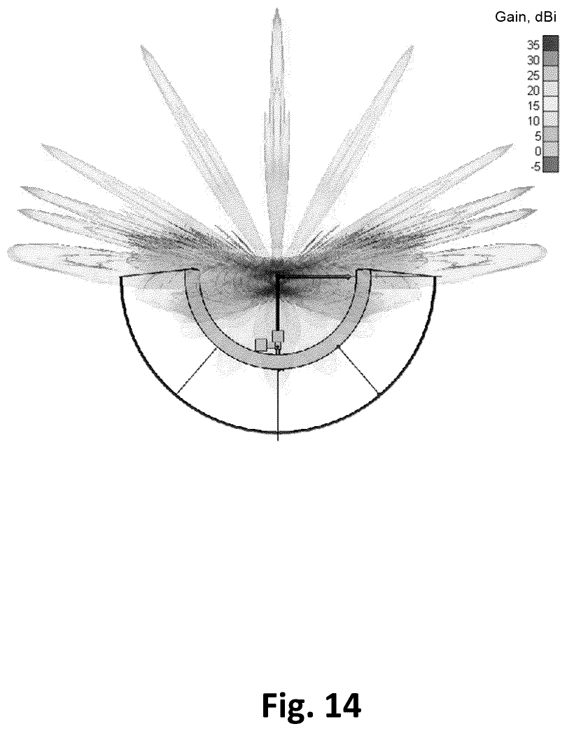

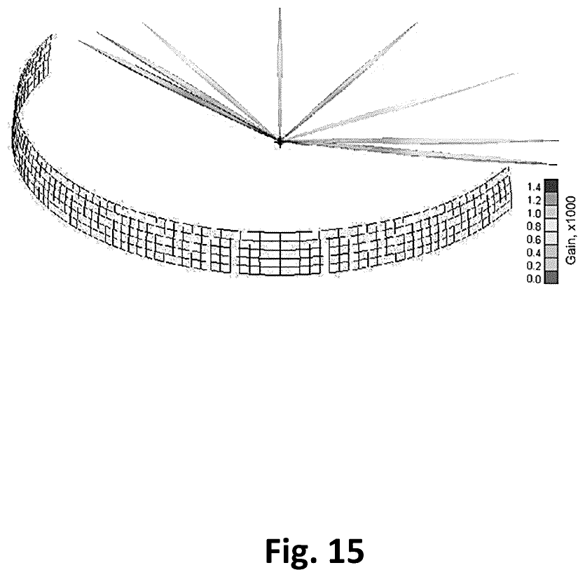

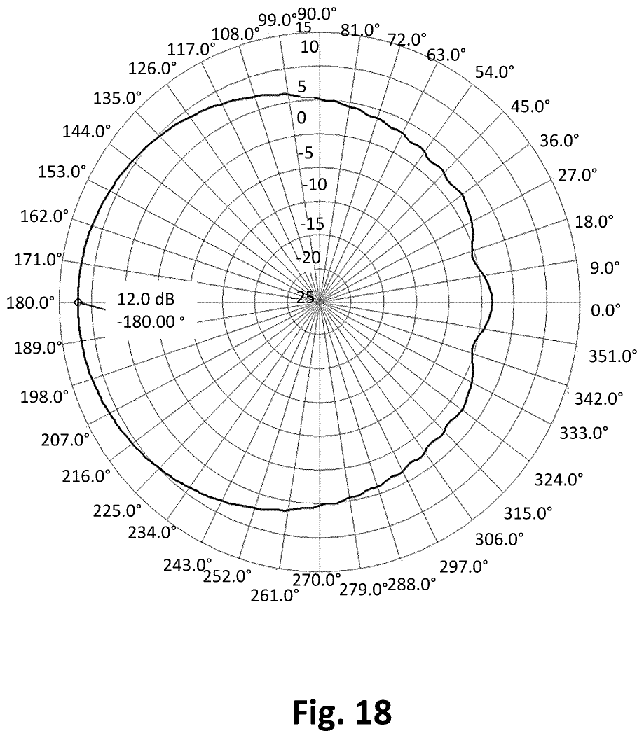

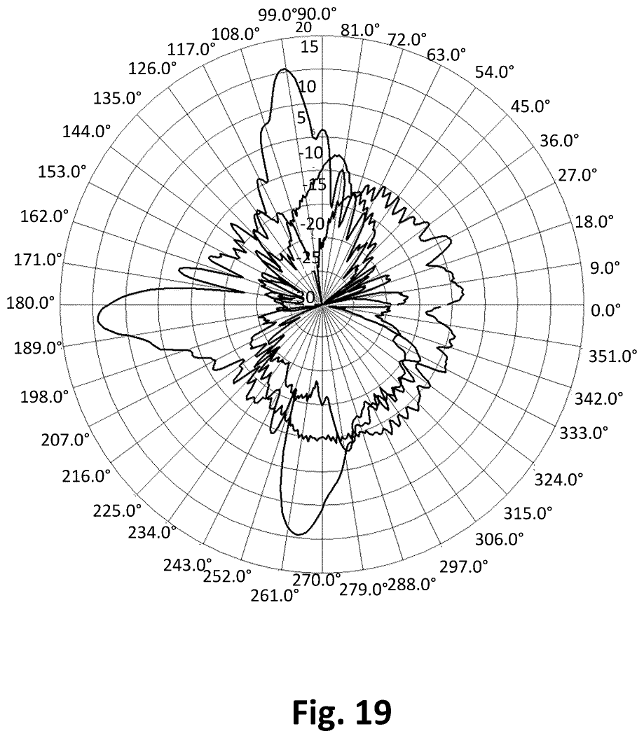

FIG. 18 presents the feed elevation pattern and FIG. 19 shows azimuthal pattern of feed formed by activated elementary antennas. Once beam steering approaches to ±85°, the resulting gain of the antenna starts to decrease since reflecting aperture loses area when moving toward edge. FIGS. 13 and 14 show variety of scanned beams with wide steering range ±85° while FIG. 15 shows steering range in 3D format. All the antenna pattern simulation were performed using simulation software WIPL-D.

The software EDX V.10 was used for cellular BS coverage simulation. Table 2 shows principal link budget parameters used to simulate down-link coverage. Achieved distance in line-of-sight toward UE using the invented antenna is 9 Km while SNR is greater than 10 dB. That distance is 460 times greater than existing down-link coverage.

TABLE 2
Link budget parameters for downlink:
Base station (BS)

| Frequency | 28 | GHz |
|---|---|---|
| Base station antenna height AGL | 20 | meters |
| Base station antenna peak gain | 31.2 | dBi |
| Polarization | Horizontal | |
| Transmit output power | 2 Watt (3 dBW) | |
| BS transmit peak EIRP | 33.2 | dBW |
| BS beam azimuth orientation | 120° | |
| BS beamwidth 3 dB | | |
| BS beam tilt | 0° | |
| Base station site elevation | 142 | meters |

| | |
|---|---|
| Base station site coordinates | 39°6′7.42″N/77°9′25.89″W |

User equipment (UE)

| User equipment height AGL | 1.5 | meter |
|---|---|---|
| User equipment antenna peak gain | 11 | dBi |
| UE Beam peak azimuth orientation | Toward BS | |
| UE Beam width 3 dB | | |
| UE station site elevation range | 80-150 | meters |
| User equipment receive noise figure | 15 | dB |
| Noise bandwidth | 100 | MHz |
| UE estimated SNR range | 5-30 | dB |

| | |
|---|---|
| SNR overage software tool | EDX |
| Electromagnetic wave propagation model | Longley-Rice |

Table 3 reflects principal parameters used for simulation up-link link budget coverage. Achieved distance in line-of-sight toward UE using the invented antenna is 6.7 Km while SNR is greater than 5 dB. That distance is 135 times greater than existing down-link coverage.

TABLE 3
Link budget parameters for uplink:
User equipment (UE)

| Frequency | 28 | GHz |
|---|---|---|
| UE antenna height AGL | 1.5 | meter |
| UE antenna peak gain | 11 | dBi |
| Polarization | Vertical | |
| Transmit output power | | |
| UE transmit peak EIRP | −5 dBW (25 dBm) | |
| UE beam azimuth orientation | 240° | |
| UE beamwidth 3 dB | | |
| UE beam tilt | 0° | |
| UE site elevation | 170 | meters |

| | |
|---|---|
| UE site coordinates | 39°8′24.05″N/77°4′14.41″W |

Base station (BS)

| BS height AGL | 20 | meters |
|---|---|---|
| BS antenna peak gain | 31.2 | dBi |
| BS azimuth orientation | Toward BS | |
| BS beamwidth 3 dB | | |
| BS site elevation range | 80-150 | meters |
| BS receive noise figure | 5 | dB |
| Noise bandwidth | 100 | MHz |
| BS receive estimated SNR range | 5-30 | dB |

| | |
|---|---|
| SNR overage software tool | EDX |
| Electromagnetic wave propagation model | Longley-Rice |

What is claimed is:

1. A base station antenna for narrow beamforming with wide steering capability, the base station antenna comprising:
a curved rectangular plate reflector of a spheroid profile; and
a circularly shaped waveguide, foci of the curved rectangular plate reflector and the circularly shaped waveguide are common, wherein the circularly shaped waveguide have slots dispersed throughout a length of the circularly shaped waveguide, wherein the slots are configured to be independently and electronically activated forming elementary radiators along foci circumference line.

2. The base station antenna according to claim 1, wherein the base station antenna does not have any phase shifters.

3. The base station antenna according to claim 1, wherein selective and consecutive activation of the elementary radiators in groups along the length of the circularly shaped waveguide results in beam steering along an azimuthal plane.
